(19) United States
(12) Patent Application Publication
(10) Pub. No.: US 2011/0295673 A1
(43) Pub. Date: Dec. 1, 2011

(54) RESTRICTED USE CONSUMER COUPON AND METHOD USING SAME

(76) Inventors: Gail E. VanNoller, Lowell, MI (US); Elmer L. Robinson, JR., Grand Rapids, MI (US)

(21) Appl. No.: 12/788,729

(22) Filed: May 27, 2010

(51) Int. Cl. G06Q 30/00; G06Q 10/00

(52) U.S. Cl. 705/14.26; 235/375; 235/380

(57) ABSTRACT

A computer system (100) for use by a retailer with a restricted use consumer coupons (100) includes a point of sale (POS) computer (201) for providing information regarding redemption of restricted use coupons at the POS. A central promotion server (203) is used for communicating with the POS computer (201) for storing restricted use coupon data. A validation computer (205) is used for rendering restricted use coupon data from the retailer or customer and providing the data to the central promotion server (203). The retailer can then provide restricted use coupons containing traceable data to a server (211) for distribution to consumers through one or more of channels of trade.

### FIELD OF THE INVENTION

The present invention relates generally to retail store coupons and more particularly to store coupons that include security features for preventing fraud.

### BACKGROUND OF THE INVENTION

As seen in prior art FIG. 1, an “in-store” coupon is a transportable document or device that entitles the holder to a financial value under a number of predetermined conditions such as: 1) the document is used at a participating retailer as a cash-equivalent media; 2) the conditions defined on the document are met; 3) the coupon's barcode is scanned or key entered on the retailer's point-of-sale (POS) system; and 4) the expected value is received by the coupon carrying customer.

Coupon issuance via traditional print media, such as newspapers, is a long and well known practice used for product promotion to store customers and/or consumers. The retailer is typically funded by manufacturers and coupons that are usually product specific. Sophisticated POS systems are able to enforce restrictions on duplicate scans within the transaction along with ensuring the intended product is being purchased via family code linkage. Both product and item based coupons are, in one sense, self-policing from a fraud perspective as the customer needs to buy the product to obtain the savings. Unfortunately, fraudsters have learned how to increase the value of the coupon by modifying the appropriate data within the bar code along with modifying the corresponding content. This has the effect of costing the manufacturer more than intended due to this type of counterfeit activity.

In addition to product-based coupons, retailers may choose to reward shoppers for their shopping behavior that may not be necessarily related to a specific product item. These are often known as transaction level coupons. For example, a coupon might offer to purchase a well known brand product and receive $1.00 off for the buyers your next purchase at the purchasing store or a partnering merchant location. Another example of transaction level coupons would be to sign up for a weekly newsletter and in return receive $10.00 off from your next shopping trip where the purchaser would spend $50.00 or more. Therefore, whether the coupon is issued to a specific customer or delivered as a result of a prior action, these “higher value” transaction level coupons create more risk if duplicated or are shared since the purchase requirements are broader. Unintended counterfeit usage can cost the retailer far more than what it anticipated since the retailer was not intending to reward such an intended action.

With the advent of at-home software and printers along with easily accessible bar code generation software, high value coupons can be easily duplicated. As a result, coupon fraud often costs the retail industry between an estimated $100 million/year and $500 million/year. The rapid growth of at-home personal computers has brought on new challenges of counterfeit paper coupons as well as new methods of coupon distribution and issuance. These types of at-home issuance options are often called electronic, digital or print-at-home coupons. Although issuing coupons via digital methods such as email and Internet sites can vastly increase their consumer penetration, their duplication can now be as simple as printing multiple times, forwarding to all in your address book and even posting on a web site to share with the world. System methods to deliver targeted, higher value coupons using digital or paper coupon methods are needed while preventing coupon duplication and inappropriate sharing are needed. Many methods have been devised to stem this type of activity; however, none have fully delivered the anticipated results.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an illustration of a store coupon as used in the prior art.

FIG. 2 is a diagram illustrating a restricted use consumer coupon bar code used in accordance with an embodiment of the invention.

FIG. 3 is a block diagram illustrating a coupon redemption system used in connection with the restricted use consumer coupon in accordance with an embodiment of the present invention.

FIG. 4 is a flow chart diagram illustrating the issuance of the restricted use coupon and its use in direct mail, email and Internet distribution in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENT

Before describing in detail embodiments that are in accordance with the present invention, it should be observed that the embodiments reside primarily in combinations of method steps and apparatus components related to restricted use coupons. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of the restricted use coupons as described herein. Alternatively, some or all functions could be implemented by a state machine that has no stored program instructions, or in one or more application specific devices, in which each function or some combinations of certain functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs with minimal experimentation.

In accordance with an embodiment of the invention, in order to properly incentivize or influence shopping behavior, a physical activation or “trigger” of some sort must be presented by the customer at the retail check-out lane. If a coupon is simply granted to the customer at the check-out, the discount may not have been expected and therefore is not noticed or fully appreciated which is a poor use of promotional dollars and goodwill. In order to best protect the retailer against coupon fraud, physical triggers used at check-out can include such means as: 1) the traditional paper coupon document with a barcode whether from newsprint or print-at-home; 2) a smart mobile phone or personal digital assistant (PDA) device that can display a barcode image; 3) a membership or loyalty type card; and/or 4) a customer or cashier entered code such as a promotional code, telephone number or unique numerical user identification. All of the above can be delivered to customers digitally via email notifications or web sites and some, such as a promotion number, can be sent via text messaging to mobile telephones.

As should be evident to those skilled in the art, traditional print media, by nature of its delivery, is not a viable candidate for creating secure, non-duplicatable, restricted use coupons. Whether distributed in newsprint, fliers or free shopping guides, print coupons are already duplicated by the printer and there is limited control on the direction toward an intended consumer target. Traditional print media coupons will likely continue to be lower value, product based coupons until, if and when, they are obsolete by electronic channels.

When a print media coupon is partnered with a loyalty or membership card, a measure of security is inherently introduced to mitigate fraud risk. This method has already been adopted by many retailers and partnering vendors. Essentially, the coupon is no longer a paper document but instead its function has been transferred to the membership card. The controls exist during this selection and transfer process where only the membership card holder is eligible for the savings. Thus, promotion codes entered at POS are also not really coupons any longer. Providing security for print-at-home coupons has already been approached from many different angles. However, these processes are often intrusive to the customer, labor intensive in the retailer lane or, simply, have not solved problems for preventing fraud.

The prior art includes various examples of coupon fraud prevention techniques such as: 1) requiring the download of a browser-based print module prior to printing the coupon that delivers, in part, traceable codes which subsequently limit how many times the coupon can be printed. Typically, the digital issuers of these coupons will choose to prevent the barcode image from appearing on the screen to prevent lifting via image capture technology; 2) as used in combination with these print module controls, restricting the number of prints and encrypt codes on a document specifying the date and time the coupon was printed. This requires cashiers to compare the encrypted code to the visible data. This is a low-tech way to catch photo copying after printing; 3) deploying hand held decoders at the POS to read watermarks and encrypted data; and 4) finally, prior to printing or selecting coupons, requiring the user to create an account in which a membership card is issued or a number is assigned. The enrollment process generally requires a double opt-in e.g. email authentication. The customer would then provide their account number or card during coupon redemption at the POS for limiting inappropriate sharing. All of these tactics present a level of intrusion to the customer i.e. decreasing coupon penetration and effectiveness while also increasing the overall time spent in the checkout lane while relying on the cashier to enforce these policies.

Thus, the present invention is a system and method of digital delivery that does not require a subsequent action on the part of the receiving consumer beyond printing the coupon nor does it increase check-out time in the lane. As will be evident from the description herein, the invention can operate as either a closed loop system for controlling both the issuance and redemption of coupons or as an open loop system where external partners can participate by invoking proprietary web service application programming interface (API). Print-at-home, digital or Internet coupons that are produced outside of the system will continue to present financial risk. Thus, in order limit risk, the “holy grail” of coupon redemption is a true once-and-done coupon where the coupon becomes spent and is not reusable. If the physical coupon is duplicated, it will be denied and fail at the POS for reason of “coupon already redeemed.”

In accordance with the invention, if the same numeric schema is followed but a new traceable number or value that is encoded into the bar code, the redemption will fail for reason of not a valid coupon. While devising the system to meet these objectives, three additional features were added to the bar code that work to vastly increase the coupon's business intelligence value:
a) an indicator is added in the bar code that represents the channel of trade used to distribute the coupon for enabling business intelligence around channel effectiveness;
b) customer data such as a hashed email address or telephone phone number is added in the bar code for identifying customer identity so that the retailer can identify to whom the coupon was issued; and/or
c) an indicator such as a phone number, loyalty number, customer number, hashed email address or the like is added to the bar code for defining that type traceable value contained in the coupon.

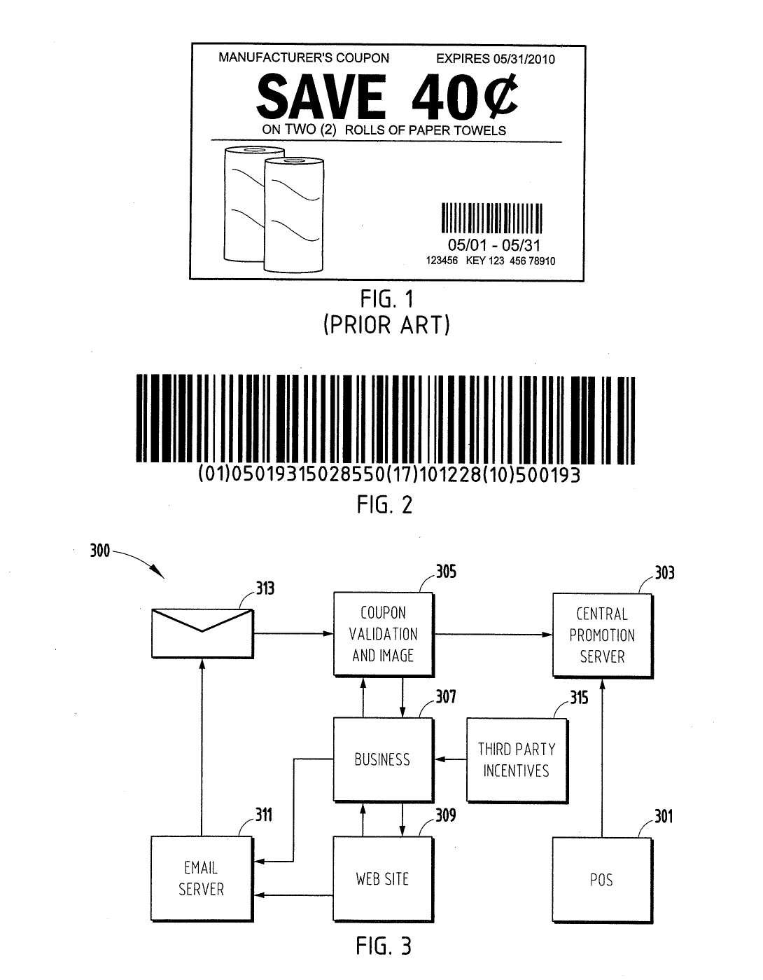

FIG. 2 is a diagram illustrating a restricted use consumer coupon bar code used in accordance with an embodiment of the invention. In use, the invention provides for a bar code schema that is defined and an accompanying POS system is adapted to recognize the schema. In one embodiment, the schema is constructed as a 32 long numerical character code of 128 bars. A 128 bar code type is used given the length of the data that is to be embedded therein. The 128 bar code is the standard bar code construction type and is readable by the vast majority of retail POS systems. The numbers used in FIG. 1 are by way of example only.

UUUUUUUUUUUXXXXXXCCCNTTTTTTTTTTTTT (1)

In field 1, a traditional eleven data component UPC is shown by a series of “U” characters as is found on current coupons that are validated through the merchant's central promotion server. In use, a restricted use coupon must be checked against a central database to authenticate the coupon's viability and if the database is not available due to network issues or other problems, an alternative method of redeeming the coupon is needed. Thus, placing the “traditional” data elements within the barcode accommodates any offline conditions but this value has a secondary purpose as when partnered with the traceable number. The secondary purpose occurs as the data creates a different coupon value such that the same traceable number can have many active coupons at the same time.

UUUUUUUUUUUXXXXXXCCCNTTTTTTTTTTTTT (2)

In field 2, this is a six character vendor identification represented by the “X” characters.

There sole purpose is to inform the POS software of the barcode's intent such that the POS software recognizes when it first reads a barcode as to which type of bar code is represented (in this case a code 128). A value, or values, within the numeric construct work to inform the POS of any subsequent actions that are to be taken. This occurs unless the same action is always performed for a specific barcode type. For example, typically a UPC A will always look first at a UPC/PLU item table on a retailer's POS system to find a match. For this vendor ID, there is set aside these six digits in positions 12 through 17 to signify to the POS that this is a restricted coupon. In use, the value must be a specific value to match a POS configurable parameter.

UUUUUUUUUUUXXXXXXCCCNTTTTTTTTTTTTT (3)

In field 3, the three characters “C” represent a three digit channel of trade. A channel of trade is that used to distribute the coupons and may include but is not limited to email, a POS system, a mobile phone, in-store promotion or a web site, etc. In other words, it denotes the means by which the coupon is delivered to a specific customer.

UUUUUUUUUUUXXXXXXCCCNTTTTTTTTTTTTT (4)

In field 4, one character “N” represents an identification number type. This identification number is a traceable number that can overlap with other numbers such that a means of separating potential duplicates is needed. These numbers might represent certain user identification and can be of various types such as telephone number, a modified/hashed email address, a customer or member number or a sequentially assigned number to a particular customer. With the number type being a single digit (0-9), up to 10 number types can be defined in this field.

UUUUUUUUUUUXXXXXXCCCNTTTTTTTTTTTTT (5)

In field 5, an eleven character traceable number is used to identify by number type as noted above. If the information known about a customer is non-numeric, a one-way hash employing check sums can be used to convert to a numeric number. For example, smith@email.com might be converted to the number sequence 59132499126. Every time smith@email.com is run through this algorithm, the same numeric results will occur. Those skilled in the art will further recognize that it is easier to use personally identifiable data about the customer such as their email address or phone number. However, if this information is not available, sequentially advancing numbers can be used with a random, large skip pattern to avoid risk of a counterfeiter identifying the pattern and creating coupons that have not yet been redeemed by the legitimate party. Once a POS system reads this barcode and if the Vendor ID indicates this is a “once and done” type coupon, 20 relevant digits are extracted and submitted to the central promotion server. This occurs in order to perform various functions such as: 1) determining if this 20 digit number was pre-staged; 2) determining if the 20 digit number was already redeemed; and 3) determining what the offer conditions are for this coupon.

The 20 digits extracted are those noted in fields 6 and 7 below:

UUUUUUUUUUUXXXXXXCCCNTTTTTTTTTTTTT; or alternatively (6)

UUUUUCNTTTTTTTTTTTTT (7)

FIG. 3 illustrates a block diagram of a coupon redemption system that is used in connection with the restricted use consumer coupon as described herein. The coupon redemption system 300 includes a POS terminal 301 that communicates electronically with a central promotions server 303. The business 307 issuing a restricted use coupon can communicate with both a web site 309 as well as directly with an email server 311. The email server can send coupons 313 via email to a location that works to image and validate the coupon 305. This information is supplied to a central promotion sever 303 that prevents the use and redemption of invalid and counterfeit coupons at the point of sale 301.

In use, if there is a match of a pending pre-staged record and if not yet redeemed, the offer data is returned from the central promotion server 303 back to the local POS 301 where the POS system validates the coupon whether the conditions of the coupon have been met. The skilled in the art will further recognize that coupon redemption using an “in-store” promotion system is not a new approach as the barcode of a transaction level coupon can be the trigger to a promotion as opposed to a traditional manufacturer's coupon (NSC5) where the family code and coupon tender value are contained within the bar code. In-store promotion systems are often used when the retailer uses a funded promotion as opposed to a manufacturers NSC5 type coupon. Thus, in contrast to methods of the prior art, the present invention uses a one-to-one match at the central promotion server 303 as opposed to a one-to-many type match.

If the conditions of the offer are met, then a post transaction update message is sent to the central promotion server 303 to mark the 20 digit ID as redeemed. If the conditions of the offer were not met, the coupon is not marked as redeemed. If systems are fully operational, this update occurs within 0.5-3.0 seconds of the redemption occurring. Those skilled in the art will recognize that there is some risk for fraud if manned, or self-checkout lanes were running simultaneously when duplicated coupons are swiped on different lanes substantially simultaneously occurring in the same second. Although it is possible that the central promotion server 303 positively responds to both requests since the post transaction redemption update had not yet occurred, this scenario is difficult to achieve and unlikely. In another embodiment, one type of work around for this type of situation is to provide a temporary lock on the offer until either the post-transaction update is received or a time out value is exceeded.

If the POS 301 is disabled or offline and unable to reach the central promotion server 303, the local POS system recognizes that the restricted use coupon cannot be verified at this time. Consequently, the offer information cannot be retrieved and the customer would not obtain their expected benefit from redeeming this coupon. Under these conditions, only the first 11 digits of the bar code are extracted and this information is used as a traditional trigger for the coupon. The first 11 digits would not be valid if scanned in the UPCA format. Only if the coupon is read as a restricted use coupon and the system is offline can this fallback offer be triggered. This was done to prevent circumvention of the controls either by cashiers or savvy coupon counterfeiters. Further, during the offer preparation process, the data analyst will have pre-staged both the restricted use offer conditions and a back-up, offline offer. The purchase requirements are still enforced (e.g., spend $25.00 and receive $5.00 off) but the offline offer does not enforce the condition of assuring the unique coupon was pre-staged and has not yet been redeemed. Store level transaction logs capture all of the barcodes data elements in which the data will ultimately reside in the appropriate columns within a data warehouse transaction history table for use in connection with business intelligence.

Additionally, a third party 315 wishing to provide discounts and/or other incentives to purchase goods and services can also send this type of information by uploading this data directly to the business 307. Thereafter, this data can be filtered, formatted and distributed to potential customers in the form of restricted use consumer coupons as provided herein.

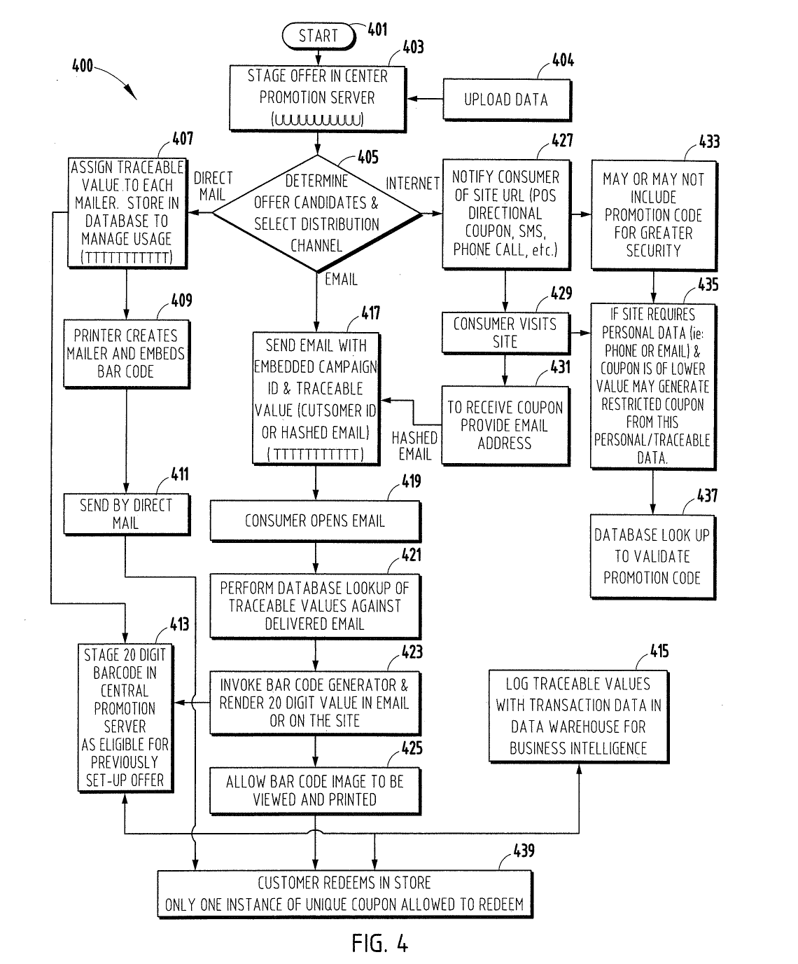

FIG. 4 is a flow chart diagram illustrating steps used in the issuance of the restricted use coupon when used with direct mail, email and Internet distribution in accordance with an embodiment of the invention. The issuance process 400 begins 401 with stating of an offer at the central promotion server of a retailer 403. The offer is most often based on data from business or retailer however a third party promoter 315 wishing to provide discounts and/or other incentives to purchase goods and services can also send this type of information by electronically uploading this data directly to a promotion server where the offer is staged 403. Thereafter, this data can be filtered, formatted and distributed to potential customers in the form of restricted use consumer coupons as provided by the methods described herein.

The central promotion server works to determine, identify and select candidates using a unique distribution channel such as direct mail, email, Internet distribution or other forms of wired or wireless communication by which a consumer may receive the restricted use coupon. If direct mailing is desired, data denoting a traceable value is assigned to the mailer containing the coupon and this information is stored in a database (db) for managing its usage 407.

The assignment of the unique number 407 to the coupon is accomplished by embedding the unique number in the coupon's or mailer's bar code. The mailer can then be printed 409 and sent through postal channels by direct mail to potential customers. After the customer data or traceable value is assigned by the central promotions server, the 20 digit barcode is staged, i.e., stored as eligible for redemption based on the set-up retailer's offer 413. The traceable value can later be validated in substantially real time 439 at a point of redemption. Business intelligence data can also be late retrieved using log traceable values with transaction data in a database warehouse 415.

Thus, the method of the invention not only works to select a unique number but also pre-stages the unique number as a “redemption eligible” number on a real time basis. The alpha and/or numerical data elements used in the bar code can then be tied to a targeted customer. Thus, the majority of pre-staging can occur at various time frames depending upon the delivery channel. The direct mailer is likely pre-staged before the mailer is sent, i.e., usually several days before the customer will receive the mailer in their postal mail box and attempt to redeem the coupon at the store.

For digital delivery via email, a similar approach can be used. The offer is staged 403 and potential candidates are determined 405. An email is then sent 417 such that the email has an embedded image tag that can be used by the potential customer. The image tag can include both a campaign or promotion number and the traceable value. Since an outbound email is sent embedding these traceable values, this allows these numbers to be easily controlled. When the images are requested to be downloaded from a retailer application, a promotional campaign identification (ID) and the traceable number are passed to this software application 317 that performs a database “look-up” function. The campaign ID is used to obtain the number type and channel of trade as well as the assigned UPC bar code. The email is sent to the consumer and when opened 419, a database lookup of the traceable values is performed against the delivered email. Thus, the traceable number is validated against a delivered email address for that coupon “campaign” to ensure legitimacy of the coupon. If both are affirmed successful, a bar code generator is then invoked 423 with the full 20 digit numeric string and barcode image needed for POS scanning. A communication is then sent to the promotion server for rendering the 20 digit value as eligible for this offer. Thereafter, the bar code image will be available for viewing and printing 425 where it can be later redeemed by the consumer 439.

Any error in this process might include a message which denotes that “the campaign has expired” or “does not exist.” In situations where an email address is not valid, this will cause a different image to be returned instead of the bar code with the appropriate error message. If no error was encountered, then in addition to rendering the barcode for the customer, a web service on the central promotion server can be called to pre-stage the 20 digit number that will be passed up from the POS. This occurs in seconds providing ample time for that coupon to be enabled at the POS before the customer is able to scan it at a POS reader. The number of times that a customer can view and print their email coupon is not restricted as the customer may be waiting to print at-home or at a more convenient time. Each barcode image rendered will contain the same values and, consequently, is only able to be used/redeemed a single time.

Alternatively, a second method of digital coupon delivery beyond the email channel can also occur when the customer visits, or is redirected to, a web site. Since an email was not sent with one or more embedded traceable numbers, a different method to assign these traceable values is necessary. The method to accomplish this is disclosed in greater detail herein; however, those skilled in the art will recognize that the computer back-end systems are substantially the same between web site issuance and the email issuance channels. The primary difference is that the campaign ID is derived from the site's uniform resource locator (URL) as opposed to an embedded campaign ID as would occur with an outbound email.

Further, FIG. 4 also illustrates a process used when restricted use coupons are issued from an Internet web site. This process starts 401 where an offer is staged at a central promotion server 403 and any number of appropriate customer candidates are determined for this type of web site distribution channel 405. A coupon/barcode is generated on a web site which can also work as a true one time redemption or “once-and-done” type coupon. Using this method, the consumer is notified of a site URL at the POS, through either a short messaging service (SMS) text communication, a mobile phone call or the like 427. The URL may also include a promotion code for providing the consumer access and enhancing the level of security 433 for fraud prevention.

When the consumer visits the web site 429, the site may also prompt the consumer requiring personal data such as a phone number or email address 431. In situations where the consumer is required to provide such a personal email address 431, the email address can be hashed, i.e., randomly encoded using an encryption algorithm, where it can then be provided to the central promotions server. Thereafter, an email message can be sent to the consumer 417 allowing the consumer to view and/or print their own restricted use bar code image as described herein. When the restricted use coupon is redeemed by the consumer 439, a traceable value such as the hashed email address, can be verified before the coupon is accepted at the POS. In cases where personal data is required without a lookup of the traceable value against a delivered email, those skilled in the art will recognize that this process will not be as secure as using a hashed email address since personal data can easily be fabricated. In these cases, personal data can also be combined with a promotion code for providing a higher level of security. In these situations, the personal data can be used to validate the promotion code 437 for enabling functionality of a bar code generator. This allows the consumer to generate a 20 digit bar code image from an email 423. Thereafter, the bar code can be viewed and printed 425 for later redemption by the consumer 439.

Using this process, whether the web issued coupon is copied, forwarded or modified, the barcode cannot be redeemed more than once at the POS. Unlike when coupons are issued direct to the channel (i.e., an email address or a phone number), the 128 character code will ultimately contain the traceable values of the initially embedded image tag (typically the address) to whom it was delivered. However, when issued by consumers selecting (or being rewarded for an action) on a specific web without a member sign-on, there is often little known about the consumer landing on this site. Those skilled in the art will further recognize that IP addresses are not unique and dropping cookies of unique keys are far from infallible. Requesting personal information used to construct the traceable elements of the coupon is not secure as the customer can readily return to the site many times providing new and erroneous personal information.

Hence, a retailer's web site campaign may use a secondary control in order for the customer to obtain the expected print-at-home coupon. When the campaign ID is being validated by the host application, an attribute will indicate whether the secondary control is necessary. If yes, the customer will need to provide an email address to where the coupon is to be sent. The email address of where the coupon was sent becomes the traceable foundation for the coupon value and not any personal identification gathered either overtly or surreptitiously that is to easily fictionalized or modified.

During the setup of the campaign, a business determines whether the customer's email is necessary usually based on a “sweet spot” between coupon value and the customer abandoning their request for the coupon due to intrusiveness. The content experienced by customers on a web site and what sequence content is viewed on their screen is driven by this parameter. If low value and self initiated email is sent to the customer, then the coupon with a visible bar code can simply appear on the screen where it may be printed via the browser or, optionally, emailed to self. If a high value and self initiated email is sent to the customer, then the coupon does not appear on the screen and a valid email address must be entered for the customer to obtain the coupon. While this narrows the risk for coupon fraud, the risk is not eliminated as with email authentication since there is still the opportunity for a consumer to open multiple email accounts for which the coupon can be sent. This is a “low tech” opening such that there is a time investment on the part of the fraudster to exploit this. Email accounts can certainly be opened with no authenticating information but they are relatively time consuming as hotmail.com, aol.com, gmail.com and other web-based email providers all require an enrollment process that is not scriptable due to the use of Completely Automated Public Turing test to tell Computers and Humans Apart (CAPTCHA) or the squiggly type of letters that are not always readable. While not benefitting the attacker, other malicious activity can occur with enforced, send-to-self email such as re-entering the site and sending the coupon to valid email accounts in your address book or even manufactured or ill-gotten email addresses.

In other embodiments of the invention, the campaign ID/email address key may be dropped on the initiating computer such that subsequent email addresses with the same campaign ID can deliver an error message instead of allowing multiple send-to-self, send-to-friend, send-to-new self. Whatever combination was the first successful send, a subsequent attempt for the same campaign ID on the same computer will not process. The email channel can deliver high value, targeted coupons to smart phones (PDA devices) and email accounts. These coupons can be printed at-home with no extra steps for the consumer and at no risk to the retailer of inappropriate sharing or value tampering. The coupon itself can be the incentive toward the desired action or the coupon may be sent as a result of a prior action. Once redeemed, the coupon is traceable in the corporate market basket data as to whom it was delivered such that the effectiveness of the campaign can be accurately measured.

The open web site process where a customer is either redirected to the site as a result of a prior action or the web site is fully public facing also has a lot of security components around presenting a high value coupon making it an attractive option for marketers. The fraud risk with this open loop system, while not non-existent, is significantly minimized and even more so when keyed cookies are implemented. Wide spread counterfeiting is just not achievable with real time, traceable, one-to-one validations at the checkout.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The invention claimed is:

1. A computer system for use by a retailer issuing restricted use consumer coupons comprising:
a point of sale (POS) computer for providing information regarding redemption of restricted use coupons at the POS;
a central promotion server for communicating with the POS computer for storing restricted use coupon data;
a validation computer for rendering restricted use coupon data from the retailer or customer and providing the data to the central promotion server; and
wherein the retailer provides at least one restricted use coupon containing traceable data to at least one server for distribution to consumers through a plurality of channels.

2. A computer system as in claim 1, wherein the at least one restricted use coupon includes:
a plurality of numerical characters on a readable media;
a plurality of computer readable bar codes on the readable media; and
wherein the bar codes include at least one indicator representing a channel of trade used to distribute the coupon.

3. A computer system as in claim 2, wherein the channel of trade is at least one from the group of newspaper, postal mail, email, in-store promotion or web site.

4. A computer system as in claim 1, wherein the at least one restricted use coupon includes:
a plurality of numerical characters on a readable media;
a plurality of computer readable bar codes on the readable media; and
wherein the bar code includes customer data defining the identity of the customer to which the coupon was issued.

5. A computer system as in claim 4, wherein the customer data includes a hashed email address.

6. A computer system as in claim 4, wherein the customer data includes the customer's telephone number.

7. A computer system as in claim 1, wherein the restricted use coupon includes:
a plurality of numerical characters on a readable media;
a plurality of computer readable bar codes on the readable media; and
wherein the bar code includes an indicator defining the type of traceable data that is contained in the coupon.

8. A computer system as in claim 7, wherein the indicator specifies a hashed email address.

9. A computer system as in claim 6, wherein the indicator specifies a telephone number.

10. A computer system as in claim 1, wherein the server is used for email or Internet web site data.

11. A restricted use consumer coupon system comprising:
a point of sale (POS) computer for providing information regarding redemption of restricted use coupons at the POS;
a central promotion server for communicating with the POS computer for storing restricted use coupon data; and
a coupon including a computer readable bar code on a readable media that includes at least one indicator representing customer data that is traceable for verifying the identity of the redeeming customer.

12. A restricted use consumer coupon as in claim 11, wherein the coupon further includes a plurality of numerical characters printed on the readable media.

13. A restricted use consumer coupon system as in claim 11, wherein the central promotions server operates to validate the coupon redeemed by the redeeming customer.

14. A restricted use consumer coupon system as in claim 11, wherein the bar codes further include channel of trade indicia used to distribute the coupon.

15. A restricted use consumer coupon system as in claim 11, wherein the channel of trade indicia is at least one from the group of newspaper, postal mail, email, in-store promotion or Internet web site.

16. A restricted use consumer coupon system as in claim 11, wherein the customer data includes a hashed email address.

17. A restricted use consumer coupon system as in claim 11, wherein the customer data includes the customer's telephone number.

18. A restricted use consumer coupon system as in claim 11, wherein the bar code further includes an indicator defining the type of traceable number that is contained in the coupon.

19. A restricted use consumer coupon system as in claim 18, wherein the indicator specifies a hashed email address.

20. A restricted use consumer coupon system as in claim 18, wherein the indicator specifies a telephone number.

21. A printed restricted use consumer coupon system readable by a computer for use by a consumer at a retail point of sale (POS) comprising:
a readable media having a computer readable bar code such that the bar code includes customer data and an indictor denoting the channel of trade used to distribute the coupon; and
wherein the computer verifies the identity of the redeeming consumer based on the customer data before validating the restricted use consumer coupon.

22. A printed restricted use consumer coupon as in claim 21, wherein the readable media further includes a plurality of numerical characters.

23. A printed restricted use consumer coupon as in claim 21, wherein the channel of trade is at least one from the group of newspaper, postal mail, email, in-store promotion or Internet web site.

24. A printed restricted use consumer coupon as in claim 21, wherein the customer data includes a hashed email address.

25. A printed restricted use consumer coupon as in claim 21, wherein the customer data is traceable for verifying identity.

26. A printed restricted use consumer coupon as in claim 21, wherein the customer data includes the customer's telephone number.

27. A printed restricted use consumer coupon as in claim 21, wherein the bar code further includes an indicator defining the type of traceable number that is contained in the coupon.

28. A printed restricted use consumer coupon as in claim 27, wherein the indicator specifies an email address.

29. A printed restricted use consumer coupon as in claim 27, wherein the indicator specifies a phone number.

30. A method for using a printed restricted use consumer coupon readable by a retail computer system at a point of sale (POS) comprising the steps of:
determining a set of unique numbers having at least one indicator representing customer data for use with a consumer retail store coupon;
embedding the unique set of numbers in a bar code;
sending the bar code to a consumer who has been identified;
validating the unique set of numbers at a point of coupon redemption;
tracing the unique set of numbers to the customer; and
allowing the coupon to be redeemed if the unique set of numbers match the customer.

31. A method for using a printed restricted use consumer coupon as in claim 30, further comprising the step of:
including channel of trade indicia used to distribute the coupon in the bar code.

32. A method for using a printed restricted use consumer coupon as in claim 30, further comprising the step of:
providing a channel of trade that is at least one from the group of newspaper, postal mail, email, in-store promotion or Internet web site.

33. A method for using a printed restricted use consumer coupon as in claim 30, further comprising the step of:
providing a hashed email address in the customer data.

34. A method for using a printed restricted use consumer coupon as in claim 32, further comprising the step of:
including the customer's telephone number in the customer data.

35. A method for using a printed restricted use consumer coupon as in claim 30, further comprising the step of:
providing an indicator defining the type of traceable number contained in the coupon.

36. A method for using a printed restricted use consumer coupon as in claim 35, further comprising the step of:
specifying a hashed email address in the indicator.

37. A method for using a printed restricted use consumer coupon as in claim 35, further comprising the step of:
specifying a telephone number in the indicator.

38. A method for using a printed restricted use consumer coupon readable by a retail computer system at a point of sale (POS) comprising the steps of:
determining a set of unique numbers having at least one indicator representing a traceable value for use with a consumer retail store coupon;
embedding the unique set of numbers in an email message;
sending an email message containing the consumer retail store coupon from a retailer to a customer with data for generating a bar code;
invoking a bar code generator in the email message after the customer opens the email;
allowing a bar code image containing the traceable value to be printed by the customer;
performing a database lookup at a point of sale for validating the printed consumer retail store coupon with the traceable value; and
allowing the printed coupon having the traceable value to be redeemed at a point of sale after validation only one time for preventing multiple redemptions of the coupon.

39. A method for using a printed restricted use consumer coupon as in claim 38, further comprising the step of:
including a hashed email address in the at least one indicator.

40. A method for using a printed restricted use consumer coupon as in claim 38, further including the step of:
including a telephone number in the at least one indicator.

41. A method for using a printed restricted use consumer coupon as in claim 38, further including the step of:
including a retailer campaign number in the at least one indicator.

42. A method for using a restricted use consumer coupon comprising the steps of:
posting a retail coupon on a website;
locating the retail coupon on the website by a customer;
sending an email request from the customer to the retailer for sending the coupon to a predetermined email address;
embedding at least one indicator representing a traceable value in an email message with the retail coupon from the retailer to the consumer;
sending an email message containing the consumer retail store coupon from a retailer to a customer with data for generating a bar code;
invoking a bar code generator in the email message after the customer opens the email;
allowing a bar code image containing the traceable value to be printed by the customer;
performing a database lookup at a point of sale for validating the printed consumer retail store coupon with the traceable value; and
allowing the printed coupon having the traceable value to be redeemed at a point of sale after validation only once for preventing multiple redemptions of the printed coupon.

43. A method for using a restricted use consumer coupon as in claim 42, further comprising the setup of:
including an image tag of the customers email address with the at least one indicator.

44. A method for using a printed restricted use coupon as in claim 42, further comprising the step of:
including a hashed email address in the at least one indicator.

45. A method for using a printed restricted use coupon as in claim 44, further including the step of:
including a telephone number in the at least one indicator.

46. A method for using a printed restricted use coupon as in claim 42, further including the step of:
including a retailer campaign number in the at least one indicator.

47. A method for using a restricted use consumer coupon system readable by a computer for use by a consumer at a retail point of sale (POS) comprising the steps of:
providing a computer readable media having a bar code such that the bar code includes a customer telephone number to which the coupon was issued; and
wherein a computer verifies the identity of the redeeming customer by verifying the customer telephone number in the bar code with that customer before validating the restricted use consumer coupon.

48. A method for using a restricted use consumer coupon as in claim 47, further including the steps of:
including an indictor in the bar code denoting the channel of trade used to distribute the coupon.

49. A method for using a restricted use consumer coupon as in claim 47, further including the step of:
including a plurality of human readable numerical characters on the readable media.

50. A method for using a restricted use consumer coupon as in claim 48, wherein the channel of trade is at least one from the group of newspaper, postal mail, email, in-store promotion or Internet web site.

51. A method for using a restricted use consumer coupon as in claim 47, further including the step of:
including a customer email address in the bar code for verifying identity.
